(19) United States
(12) Patent Application Publication
(10) Pub. No.: US 2022/0245291 A1
(43) Pub. Date: Aug. 4, 2022

(54) APPARATUS, SYSTEM AND METHOD FOR THREE-DIMENSIONAL (3D) MODELING WITH A PLURALITY OF LINKED METADATA FEEDS

(71) Applicant: BAYA INC., Dover, DE (US)

(72) Inventor: John N. Derkach, Burr Ridge, IL (US)

(21) Appl. No.: 17/552,114

(22) Filed: Dec. 15, 2021

Related U.S. Application Data
(60) Provisional application No. 63/144,748, filed on Feb. 2, 2021.

(51) Int. Cl. G06F 30/13; G06F 30/20; G06T 17/00

(52) U.S. Cl. CPC G06F 30/13; G06F 2111/20; G06T 17/00; G06F 30/20

(57) ABSTRACT

Technologies and techniques for operating a dynamically updatable computer system. A design tool generates a three-dimensional (3D) model base having plurality of model subcomponents with different characteristics. First dynamic metadata and second dynamic metadata associated with each of the plurality of model subcomponents are received, wherein the second dynamic metadata is associated with the first dynamic metadata, and wherein the first dynamic metadata and second dynamic metadata is configured to change over time. Each of the first dynamic metadata are linked to respective portions of the plurality of model subcomponents, based on the model component characteristics. Each of the second dynamic metadata are linked to the respective portions of the plurality of model subcomponents linked to the first dynamic metadata. A 3D model is generated that includes the processed first and second dynamic metadata, wherein the first dynamic metadata and second dynamic metadata is automatically updated within the 3D model.

### RELATED APPLICATIONS

The present application claims priority to U.S. Provisional Application No. 63/144,748 to John Derkach, titled “System and Method for Linking a 3D Computer Aided Design Assembly to a Method of Procurement of a Set of Components from a Database”, filed Feb. 2, 2021, the contents of which is incorporated by reference in its entirety herein.

### FIELD OF TECHNOLOGY

The present disclosure is directed to technologies and techniques for processing metadata linked to subcomponents of three-dimensional (3D) models. More specifically, the present disclosure is directed to a computer system configured to integrate 3D modeling with a plurality of real-time metadata feeds to provide enhanced modeling and operational characteristics.

### BACKGROUND

In 3D computer graphics, 3D modeling is the process of developing a mathematical coordinate-based representation of any surface of an object in three dimensions via specialized software by manipulating edges, vertices, and polygons in a simulated 3D space. For example, Non-Uniform Rational B-Splines (NURBS), are mathematical representations of 3D geometry that can accurately describe any shape from a simple 2D line, circle, arc, or curve to the most complex 3D organic free-form surface or solid. NURBS models are typically used in processes, from illustration and animation to manufacturing. Typically, 3D models represent a physical body using a collection of points in 3D space, connected by various geometric entities such as triangles, lines, curved surfaces, etc. Being a collection of data, such as points and other information, 3D models can be created manually, parametrically, algorithmically (procedural modeling), or by scanning. The model surfaces may be further defined with texture mapping.

While 3D modeling systems are typically configured to utilize metadata that is internal (inherent/integral) to the 3D modeling system (e.g., unit lengths, angle, etc.), current systems are not configured to process external metadata, and particularly dynamic metadata that is associated with characteristics of model subcomponents of a 3D model. Furthermore, conventional 3D modeling systems are not configured to process multiple streams of dynamic metadata in a manner that allows users to utilize the metadata both on a model subcomponent level, as well as the overall 3D model itself.

### SUMMARY

Various apparatus, systems and methods are disclosed herein relating to specialized computer systems for 3D modeling and metadata linking and processing.

In some illustrative embodiments, a dynamically updatable computer system is disclosed, comprising: a communications interface, configured to communicate over a computer network; a memory; and a processor, communicatively coupled to the communications interface and memory, wherein the processor and memory are configured to: execute a design tool to generate a three-dimensional (3D) model base comprising a plurality of model subcomponents having different characteristics relative to the 3D model base; execute one or more application programming interfaces (APIs) to receive, via the communications interface, first dynamic metadata and second dynamic metadata associated with each of the plurality of model subcomponents, wherein the second dynamic metadata is associated with the first dynamic metadata, and wherein the first dynamic metadata and second dynamic metadata is configured to change over time; process the first dynamic metadata to link each of the first dynamic metadata to respective portions of the plurality of model subcomponents, based on the model component characteristics; process the second dynamic metadata to link each of the second dynamic metadata to the respective portions of the plurality of model subcomponents linked to the first dynamic metadata; and process the 3D model base to generate a 3D model comprising the processed first dynamic metadata and second dynamic metadata, wherein the processor and memory are configured to automatically update the first dynamic metadata and second dynamic metadata within the 3D model.

In some examples, a method is disclosed for operating a dynamically updatable computer system, comprising: executing a design tool via a processing apparatus to generate a three-dimensional (3D) model base comprising a plurality of model subcomponents having different characteristics relative to the 3D model base; executing one or more application programming interfaces (APIs) via a processing apparatus to receive, via a communications interface, first dynamic metadata and second dynamic metadata associated with each of the plurality of model subcomponents, wherein the second dynamic metadata is associated with the first dynamic metadata, and wherein the first dynamic metadata and second dynamic metadata is configured to change over time; processing, via a processing apparatus, the first dynamic metadata to link each of the first dynamic metadata to respective portions of the plurality of model subcomponents, based on the model component characteristics; processing, via a processing apparatus, the second dynamic metadata to link each of the second dynamic metadata to the respective portions of the plurality of model subcomponents linked to the first dynamic metadata; and processing, via a processing apparatus, the 3D model base to generate a 3D model comprising the processed first dynamic metadata and second dynamic metadata, wherein the processor and memory are configured to automatically update the first dynamic metadata and second dynamic metadata within the 3D model.

In some examples, a computer-readable medium is disclosed, having stored therein instructions executable by one or more processors for operating a dynamically updatable computer system, to: execute a design tool via a processing apparatus to generate a three-dimensional (3D) model base comprising a plurality of model subcomponents having different characteristics relative to the 3D model base; execute one or more application programming interfaces (APIs) via a processing apparatus to receive, via a communications interface, first dynamic metadata and second dynamic metadata associated with each of the plurality of model subcomponents, wherein the second dynamic metadata is associated with the first dynamic metadata, and wherein the first dynamic metadata and second dynamic metadata is configured to change over time; process the first dynamic metadata to link each of the first dynamic metadata to respective portions of the plurality of model subcomponents, based on the model component characteristics; process the second dynamic metadata to link each of the second dynamic metadata to the respective portions of the plurality of model subcomponents linked to the first dynamic metadata; and process the 3D model base to generate a 3D model comprising the processed first dynamic metadata and second dynamic metadata, wherein the processor and memory are configured to automatically update the first dynamic metadata and second dynamic metadata within the 3D model.

### BRIEF DESCRIPTION OF THE FIGURES

The present invention is illustrated by way of example and not limitation in the figures of the accompanying drawings, in which like references indicate similar elements and in which:

FIG. 1 illustrates a simplified overview of a processor-based computer system configured to perform 3D modeling and metadata linking and processing according to some aspects of the present disclosure;

FIG. 2 shows an operating environment for a device and a server for 3D modeling and metadata linking and processing according to some aspects of the present disclosure;

FIG. 3A schematically illustrates components of a device operating environment that include a model database and user interface/application programming interface (API) circuit for 3D modeling and processing dynamic metadata according to some aspects of the present disclosure;

FIG. 3B schematically illustrates a continuation of the components of the device operating environment of FIG. 3A that include a modeling/automation circuit for 3D modeling and processing dynamic metadata according to some aspects of the present disclosure;

FIG. 3C schematically illustrates a continuation of the components of the device operating environment of FIG. 3B that include a script output circuit for 3D modeling and processing dynamic metadata according to some aspects of the present disclosure;

FIG. 4 shows an operating environment for linking dynamic metadata to characteristics of a model subcomponent that is configured to be part of a larger 3D model base according to some aspects of the present disclosure;

FIG. 5 shows a simulated 3D model base generated on a device that includes a plurality of multi-level model subcomponents according to some aspects of the present disclosure;

FIG. 6 shows a simulated portion of a 3D model base generated on a device that includes a plurality of second-level model subcomponents including linked dynamic metadata according to some aspects of the present disclosure; and

FIG. 7 shows a process for operating a dynamically updatable 3D modelling computer system according to some aspects of the present disclosure.

### DETAILED DESCRIPTION

Various embodiments will be described herein below with reference to the accompanying drawings. In the following description, well-known functions or constructions are not described in detail since they may obscure the invention in unnecessary detail.

It will be understood that the structural and algorithmic embodiments as used herein does not limit the functionality to particular structures or algorithms, but may include any number of software and/or hardware components. In general, a computer program product in accordance with one embodiment comprises a tangible computer usable medium (e.g., hard drive, standard RAM, an optical disc, a USB drive, or the like) having computer-readable program code embodied therein, wherein the computer-readable program code is adapted to be executed by a processor (working in connection with an operating system) to implement one or more functions and methods as described below. In this regard, the program code may be implemented in any desired language, and may be implemented as machine code, assembly code, byte code, interpretable source code or the like (e.g., via C, C++, C#, Java, Actionscript, Swift, Objective-C, Javascript, CSS, XML, Rhino Script, Grasshopper, etc.). Furthermore, the term “information” as used herein is to be understood as meaning digital information and/or digital data, and that the term “information” and “data” are to be interpreted as synonymous.

In addition, while conventional hardware components may be utilized as a baseline for the apparatuses and systems disclosed herein, those skilled in the art will recognize that the programming techniques and hardware arrangements disclosed herein, embodied on tangible mediums, are configured to transform the conventional hardware components into new machines that operate more efficiently (e.g., providing greater and/or more robust data, while using less processing overhead and/or power consumption) and/or provide improved user workspaces and/or toolbars for human-machine interaction.

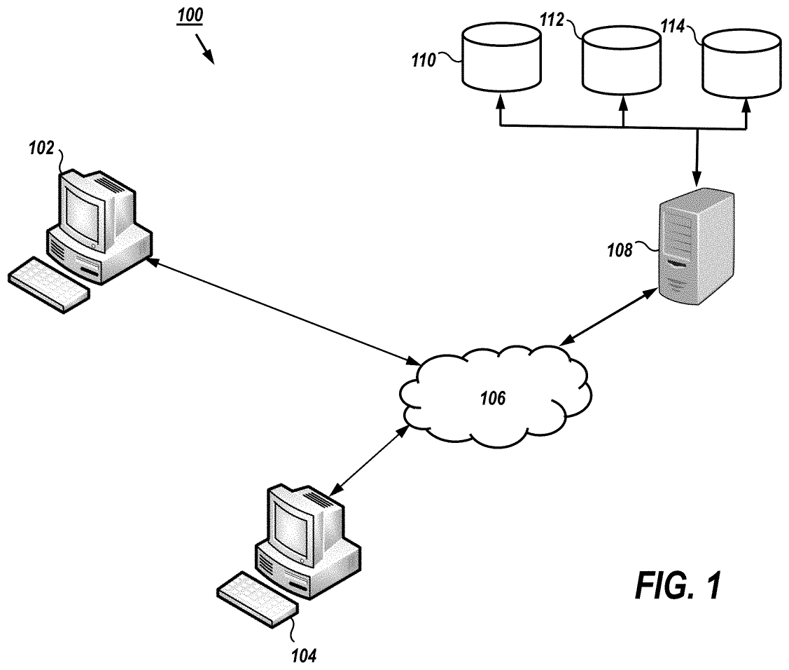

Turning to FIG. 1, the drawing illustrates a simplified overview of a processor-based computer system 100 configured to perform 3D modeling and metadata linking and processing according to some aspects of the present disclosure. The system 100 may include a plurality of processing devices 102, 104, which may be configured as specially-purposed 3D modeling workstations, and may communicate with each other via a direct wired or wireless connection (e.g., Bluetooth, WiFi), or through a local network (e.g., LAN). Computers 102 and 104 may be computers from different networks and may be physically and/or geographically remote from one another. Computers 102 and/or 104 may be communicatively coupled to a computer network 106, which is communicatively coupled to a server 108, or a plurality of servers (e.g., distributed server network, cloud, etc.). In the example of FIG. 1, server 108 may be communicatively coupled with a plurality of databases 110, 112, 114. The databases may be configured to store 3D modeling data and/or dynamic metadata, among other data discussed in greater detail below.

In some illustrative embodiments, system 100 is configured to allow a computer (e.g., 102) to generate a 3D model base on the computer and receive dynamic metadata associated with model subcomponents within the 3D model base, in real-time, and/or upon request from the processing device 102, or when any change is made to the specific item that is within an assembly to use less computing power, and not querying everything in the model every time. In some examples, the metadata, that includes dynamic metadata, may be provided from server 108 to processing device 102. The dynamic metadata may be stored in any of databases 110-114, and may be updated automatically using the server 108, which may be communicatively coupled to other computer networks (not shown for the purposes of brevity). In some examples, the dynamic metadata may be updated and provided to the server 108 and stored (e.g., via 110-114) using an external processing device, such as processing device 104. In some examples, the dynamic metadata may continue to be updated until the processing device 102 and/or processing device 104 issues a command to server 108 to lock the metadata at a specific value, causing the dynamic metadata to transition to a static metadata, and not be subject to further updating, independently from other dynamic metadata transmissions occurring concurrently with the locked metadata.

During operation, the server 108 receives information from processing device 102 that includes data relating to a 3D model base that includes pluralities of model subcomponents. Once this information is received, server 108 may begin processing the data from processing device 102 to provide pluralities of dynamic metadata associated with each of the model subcomponents back to the processing device 102. In some examples, the dynamic metadata may be provided from the server 108 to the processing device 102 as a continuous feed. In other examples, the server 108 may be configured to provide the dynamic metadata upon request from the processing device 102. Those skilled in the art will understand that the scheduling of the dynamic metadata transmission from the server 108 to the processing device 102 may be configured to suit the particular application for the system 100. As used herein, “dynamic metadata” may be defined as supplementary data associated with and/or linked to an object and/or a group of objects that is configured to be changed and/or modified independently of the processing device (e.g., 102) that generated the object or groups of objects.

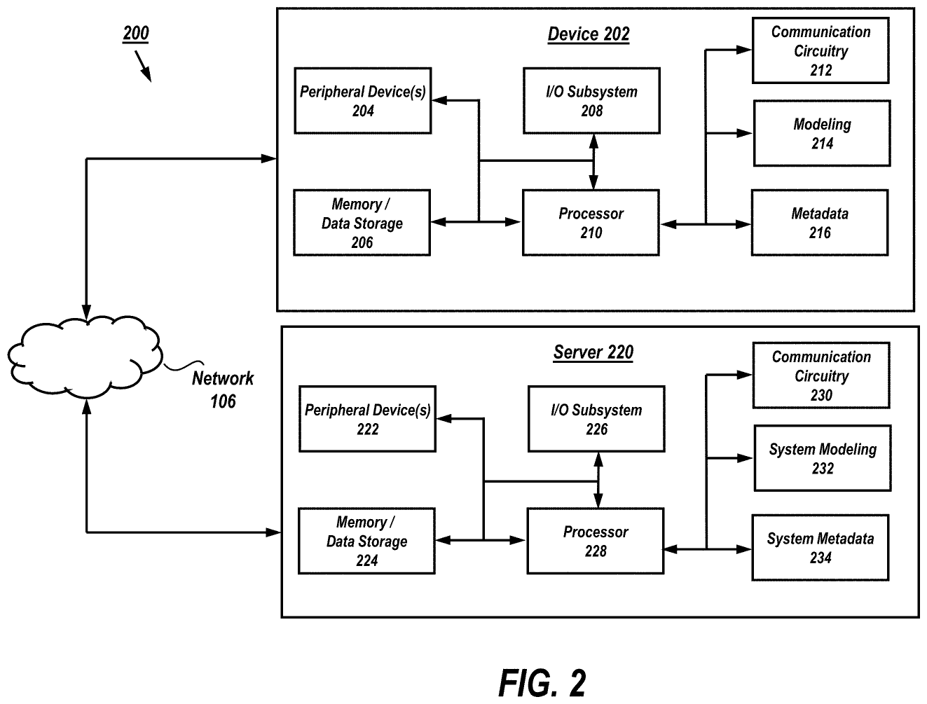

FIG. 2 shows an operating environment 200 for a processing device 202 and a server 220 for 3D modeling and metadata linking and processing according to some aspects of the present disclosure. In this example, processing device 202 may be configured as any of devices 102, 104, and a server 220, which may be configured as server 108, communicating via the network 106. In the illustrative embodiment, the processing device 202 includes a processor 210 or processor circuit, one or more peripheral devices 204, memory/data storage 206, communication circuity 212, input/output (I/O) subsystem 208, a 3D modeling circuit 214 and a metadata processing circuit 216.

It should be understood by those skilled in the art that aspects of the processing device 202, when configured as a specially-purposed 3D modeling device, operates in certain manners that differentiate processing device 202 (and/or 102, 104), as well as system 200 (and/or 100) from general purpose computing devices and systems. Some of the differences are that most 3D applications are single-threaded for designing, meaning that processor 210 clock speed should be configured to be sufficiently high to handle the requirements of rendering. Rendering, in general, is a different process that utilizes multiple processor cores and threads. As such, a rendering engine is also used to take advantage of the multiple cores and threads. Additionally, the processing device 202 should be configured to support streaming single instruction, multiple data (SIMD) extensions, as well as compute unified device architecture (CUDA) for graphics processing to provide speed and accuracy during the 3D modelling process.

Modeling circuit 214 is configured to provide modeling capabilities and processing for generating 3D model bases. Modeling circuit 214 may utilize data from model databases, user interfaces/APIs to perform 3D model processing and automation, and provide outputs for further processing. Modeling circuit 214 may be configured as a separate processing circuit, or may be used in conjunction with, or even incorporated entirely within, processor 210. In some examples, modeling circuit 214 is communicatively coupled to metadata circuit 216, which is configured to process metadata, including dynamic metadata, and incorporate as part of the 3D model base generated by modeling circuit 214. The metadata processed by metadata circuit 216 may be received from memory 206, and/or or be received from the network 106 via communication circuitry 212. Modeling circuit 214 may also be configured to process 3D model templates from memory/device storage 201 when generating a 3D model base. In some examples, modeling circuit 214 may receive 3D model templates from the server 220 via communication circuitry 212.

In some examples, modeling circuit 214 may be configured to generate and/or process characteristics of model subcomponents of a 3D model base, wherein the characteristics include, but are not limited to, characteristics indicating a type, attribute, profile, description and/or dimension of the model subcomponent. Modeling circuit 214 may further be configured to link dynamic metadata from metadata circuit 216 to model subcomponents based on the model subcomponent characteristic. In some examples, modeling circuit 214 may be incorporated into memory/data storage 206 with or without a secure memory area, or may be a dedicated component, or incorporated into the processor 210. Of course, processing device 202 may include other or additional components. Additionally, in some embodiments, one or more of the illustrative components may be incorporated in, or otherwise form a portion of, another component. For example, the memory/data storage 206, or portions thereof, may be incorporated in the processor 210 in some embodiments.

Memory/data storage 206 may be embodied as any type of volatile or non-volatile memory or data storage currently known or developed in the future and capable of performing the functions described herein. In operation, memory/data storage 206 may store various data, instructions and software used during operation of the processing device 202 such as access permissions, access parameter data, operating systems, applications, programs, libraries, and drivers. Memory/data storage 206 may be communicatively coupled to the processor 210 via an I/O subsystem 208, which may be embodied as circuitry and/or components to facilitate input/output operations with the processor 210, memory/data storage 206, and other components of the processing device 202. For example, the I/O subsystem 208 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 208 may form a portion of a system-on-a-chip (SoC) and be incorporated, along with the processor 210, memory/data storage 206, and other components of the processing device 202, on a single integrated circuit chip.

The processing device 202 includes communication circuitry 212 (communication interface) that may include any number of devices and circuitry for enabling communications between processing device 202 and one or more other external electronic devices and/or systems. Similarly, peripheral devices 204 may include any number of additional input/output devices, interface devices, and/or other peripheral devices. The peripheral devices 204 may also include a display, along with associated graphics circuitry and, in some embodiments, may further include a keyboard, a mouse, audio processing circuitry (including, e.g., amplification circuitry and one or more speakers), and/or other input/output devices, interface devices, and/or peripheral devices.

The server 220 may be embodied as any suitable server (e.g., a web server, etc.) or similar computing device capable of performing the functions described herein. In the example of FIG. 2 the server 220 includes a processor 228, an I/O subsystem 226, a memory/data storage 224, communication circuitry 230, and one or more peripheral devices 222. Components of the server 220 may be similar to the corresponding components of the processing device 202, the description of which is applicable to the corresponding components of server 220 and is not repeated herein for the purposes of brevity.

The communication circuitry 232 of the server 220 may include any number of devices and circuitry for enabling communications between the server 220 and the processing device 202. In some embodiments, the server 220 may also include one or more peripheral devices 222. Such peripheral devices 222 may include any number of additional input/output devices, interface devices, and/or other peripheral devices commonly associated with a server or computing device. In some illustrative embodiments, the server 220 also includes system modeling circuit 232 and system metadata circuit 234. In some examples, system modeling circuit 232 may be configured to provide modeling data, such as 3D model templates, to modeling circuit 214 for processing. However, in some configurations, the templates may be stored in memory/data storage 206 and processed by modeling circuitry 214 in device 202, as discussed above. System modeling circuit 232 may further be configured to receive 3D modeling data from modeling circuit 214 from device 202, and process the received data to process at least portions of the model subcomponents of the 3D model base using model subcomponent characteristics data and/or dynamic metadata from system metadata circuit 234. In some examples, the processing of the model subcomponent data would allow the server 220 to dynamically modify the metadata in system metadata circuit 234 and transmit the modified data back to device 202 for updating and processing.

Communication between the server 220 and the processing device 202 takes place via the network 106 that may be operatively coupled to one or more network switches (not shown). In one embodiment, the network 106 may represent a wired and/or wireless network and may be or include, for example, a local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). Generally, the communication circuitry 212 of processing device 202 and the communication circuitry 232 of the server 220 may be configured to use any one or more, or combination, of communication protocols to communicate with each other such as, for example, a wired network communication protocol (e.g., TCP/IP), a wireless network communication protocol (e.g., Wi-Fi, WiMAX), a cellular communication protocol (e.g., Wideband Code Division Multiple Access (W-CDMA)), and/or other communication protocols. As such, the network 106 may include any number of additional devices, such as additional computers, routers, and switches, to facilitate communications between the processing device 202 and the server 220.

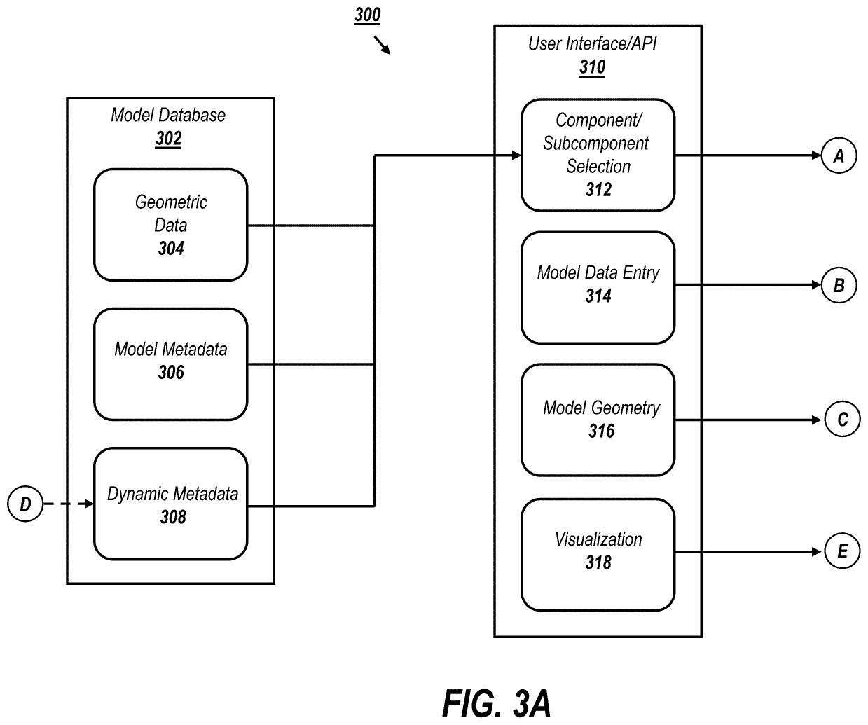

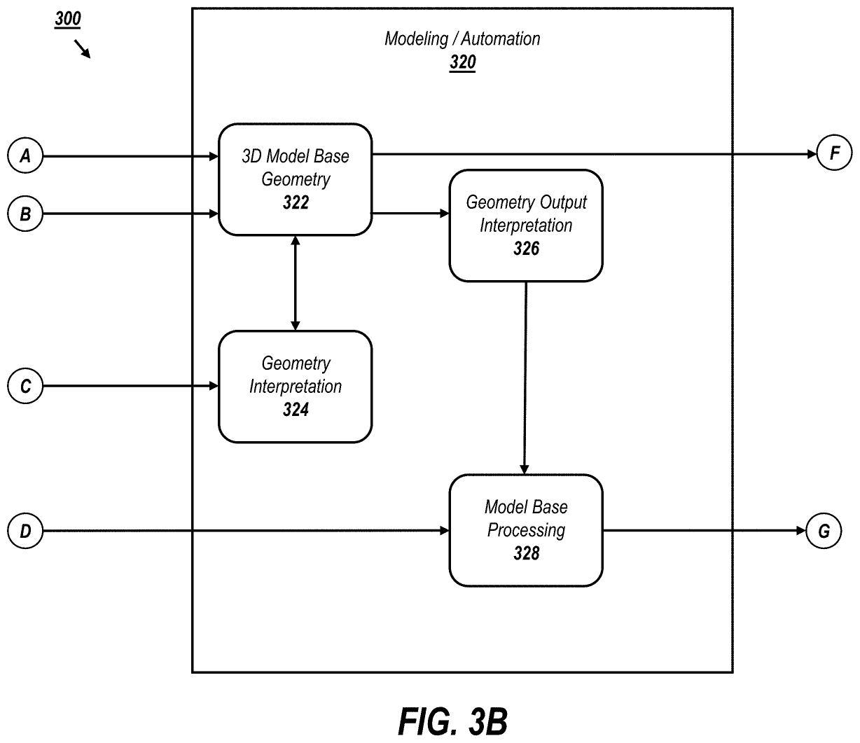

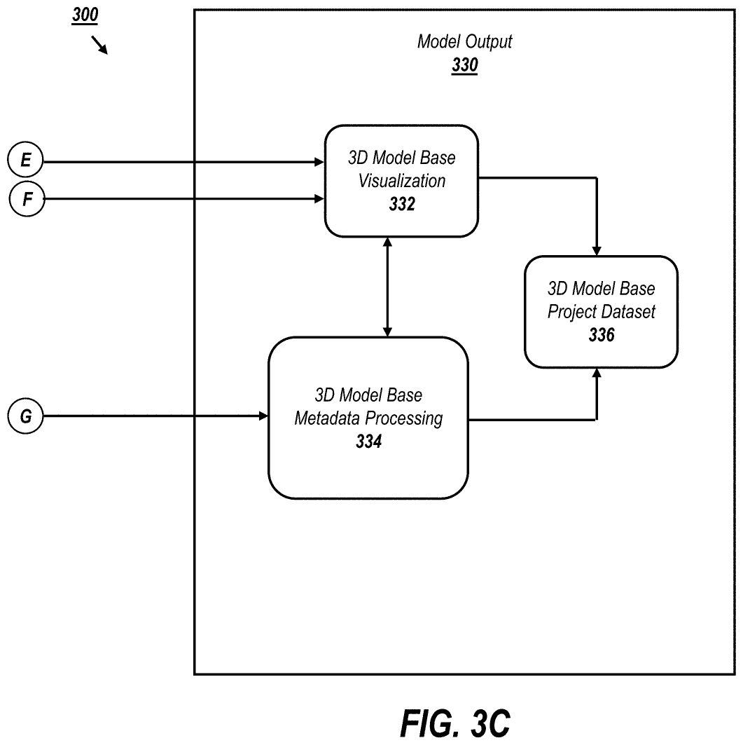

FIG. 3A schematically illustrates components of a device operating environment 300 that include a model database 302 and user interface/application programming interface (API) circuit 310 for 3D modeling and processing dynamic metadata according to some aspects of the present disclosure. In this example, a model database 302, or portions thereof, may be stored on a processing device memory (e.g., 206) or a server memory (e.g., 224). Alternately or in addition, portions the model database 302 may be shared via a computer network (e.g., 106) between the processing device memory (e.g., 206) and the server memory (e.g., 224), as well as any other processing device (e.g., 104) configured to have access to the computer network. Model database 302 may include a geometric data portion 304, a model metadata portion 306 and a dynamic metadata portion 308. It should be understood by those skilled in the art that, while model database 302 is shown in this example as being one database, the database may be divided or distributed into multiple databases as needed to suit a particular application.

Geometric data portion 304 may include 3D model base data including, but not limited to, templates, model subcomponents, etc. that may be used by user interface/API circuit 310 to generate 3D model bases. Model metadata portion 306 may include internal metadata that is associated with model subcomponents and includes, but is not limited to 3D model subcomponent characteristic data (e.g., type, attribute, profile, description, dimension, etc.). The model metadata of portion 306 may be associated with geometric data 304 in a predetermined manner when stored in model database 302, or may alternately or in addition be defined internally via user interface/API 310. Thus, during operation, a user may manually define one or more characteristics of a 3D model subcomponent when generating a 3D model base (e.g., via 314), and the defined characteristic(s) may be stored in model metadata 306. Dynamic metadata portion 308 may include dynamic metadata received (“D”) from a computer network (e.g., 106, via server 220), where the dynamic metadata is stored in 308. The dynamic metadata of portion 308, the model metadata of portion 306 and the geometric data of 304 may be received by the user interface/API 310 for generating a 3D model base.

Continuing with the example of FIG. 3A, user interface/API 310 includes, but is not limited to a plurality of circuits configured to generate a 3D model base. User interface/API 310 may include a component/subcomponent selection circuit 312, a model data entry circuit 314, a model geometry circuit 316 and a visualization circuit 318. Any or all of the circuits 312-318 may be part of a 3D design tool configuration, and may include additional components such as modeling/automation circuit 320 and model output circuit 330, and may also include additional components known in the art, which are not expressly discussed herein. In some examples, the 3D design tool may be configured as a multi-layer model that includes, but is not limited to, a core layer, a domain layer and a resource layer, wherein the core layer may process classes and/or characteristics of data models, where elements in one layer may reference elements in other layers. A domain layer may include domain-specific schemes that include specialized classes that apply only to specific domains, forming leaf nodes in an inherence hierarchy. A resource layer, which may be configured as the lowest layer, may include schemes for providing basic data structures that may be used throughout a data model. These schemes may include geometry resources, topology resources, geometric model resources, material resources and/or utility resources, among others. In some examples, when utilizing an inheritance hierarchy, the 3D design tool may process data semantically, where the meaning of objects is used as a basis for modeling inheritance relationships (e.g., objects, space/bounding, etc.).

Component/subcomponent selection circuit 312 may be configured to allow a user to select components and/or subcomponents, that may be assembled within a 3D design tool to generate a 3D model base that includes a plurality of model subcomponents. As used herein, “3D model base” may be defined as a global object, the structure of which is defined by a plurality of model subcomponents that are arranged in a manner to form the given structure. As should be understood by those skilled in the art, model subcomponents in the present disclosure may be arranged in a manner to have layered subcomponents (i.e., “subcomponent-of-a-subcomponent”), where one or more lower-level subcomponents may be arranged to be linked to each other, and may further be configured to contain dependencies upon higher-level subcomponents. Similarly, groups of model subcomponents may be configured to have dependencies on other groups of model subcomponents. In some examples, upon generation of the 3D model base, at least some of the model subcomponents may be configured to each have respective dependencies to each other, as well as having a collective dependency (i.e., all of the model subcomponents that form the structure) to the 3D model base itself. An output of the component/subcomponent selection circuit 312 (“A”) is the output to 3D model base geometry circuit 322, discussed below with respect to FIG. 3B.

Returning to FIG. 3A, model data entry circuit 314 may be configured to allow, among other features, a user to enter data that adds, subtracts, and/or modifies aspects of the 3D model base and model subcomponents, including characteristic data. Alternately and/or in addition, model data entry circuit 314 may also be configured to allow a user to interact with dynamic metadata to select and/or interact with the dynamic metadata. In some examples, model data entry circuit 314 may be configured to allow a user to select one or more of a plurality of dynamic metadata linked to a 3D model component, wherein the selection may allow executable code in the processing device (e.g., 202) to lock the value of the dynamic metadata at the moment of selection and store the locked value in memory (e.g., 206). The locked value of the dynamic metadata may then be used by the processing device to transmit messages via the network (e.g., 106) to other devices (e.g., 104). An output of the model data entry circuit 314 (“B”) may be transmitted to 3D model base geometry circuit 322, discussed below with respect to FIG. 3B.

Model geometry circuit 316 may be configured to load, create, add, subtract, and modify geometries of a 3D model base and/or model subcomponents in conjunction with model data entry circuit 314 and/or component/subcomponent selection circuit 312. An output of model geometry circuit 316 (“C”) may be transmitted to geometry interpretation circuit 324 of FIG. 3B, discussed below. Visualization circuit 318 may be configured to customize visualizations for the 3D model base and/or model subcomponents, where an output of visualization circuit 318 (“E”) may be transmitted to 3D model base visualization circuit 332 of FIG. 3C.

Turning now to FIG. 3B, the figure schematically illustrates a continuation of the components of the device operating environment 300 of FIG. 3A that include a modeling/automation circuit 320 for 3D modeling and processing dynamic metadata according to some aspects of the present disclosure. In this example, the output of component/subcomponent selection circuit 312 (“A”) and model data entry circuit 314 (“B”) are received in 3D model base geometry circuit 322 (“C”) is received in geometry interpretation circuit 324. Using the received data, the geometry interpretation circuit 324 may include functions such as validation (e.g., identifying elements in the central 3D data model), filtering, non-geometrical interpretations (e.g., ontological data interpretation, characteristic interpretation), geometrical operations, and enrichment and reasoning that includes processing of model subcomponent characteristic data, dynamic metadata, etc. The geometrical interpretations may also include functions such as linearization, planarization, vertical and horizontal connectivity processing, among others. The 3D model base geometry circuit 322, which, in some examples, may utilize the data processed by geometry interpretation circuit 324, processes the 3D model base data and generates an output (“F”) to the model output circuit 330, and also generates an output via geometry output interpretation circuit 326 using the combined data, and transmits the data model base processing circuit 328. The model base processing circuit 328 may be configured to receive the dynamic metadata from “D” and link/associate the data to produce an output “G”, as shown in the figure.

FIG. 3C schematically illustrates a continuation of the components of the device operating environment 300 of FIG. 3B that include a model output circuit 330 for 3D modeling and processing dynamic metadata according to some aspects of the present disclosure. The outputs of visualization circuit 318 (“E”), 3D model base geometry circuit 322 (“F”), and model base processing circuitry 328 (“G”) are received in 3D model base visualization circuit 332, which individually and collectively processes the data to generate a 3D model base that is ultimately rendered on the processing device (e.g., 102). In some examples, the 3D model base metadata processing circuit 334 processes some or all of the linked dynamic metadata, and provides the data for incorporation into 3D model base visualization circuit 332. The 3D model base visualization circuit 332 may be configured to process all of the data associated with a generated 3D model based, including the dynamic metadata, and render the 3D model base on the processing device (e.g., 102), including 3D model base project dataset 336. In some examples, the 3D model base project dataset 336 may be configured to continue to receive dynamic metadata via 3D model base metadata processing circuit 334, such that the rendered 3D model base on the processing device (e.g., 102) provides a display of the 3D model base, while simultaneously providing dynamic metadata associated with the model subcomponents of the 3D model base during the display. Accordingly, a user may be able to render and view a 3D model base, and view the dynamic metadata associated/linked with each model subcomponent in substantially real time.

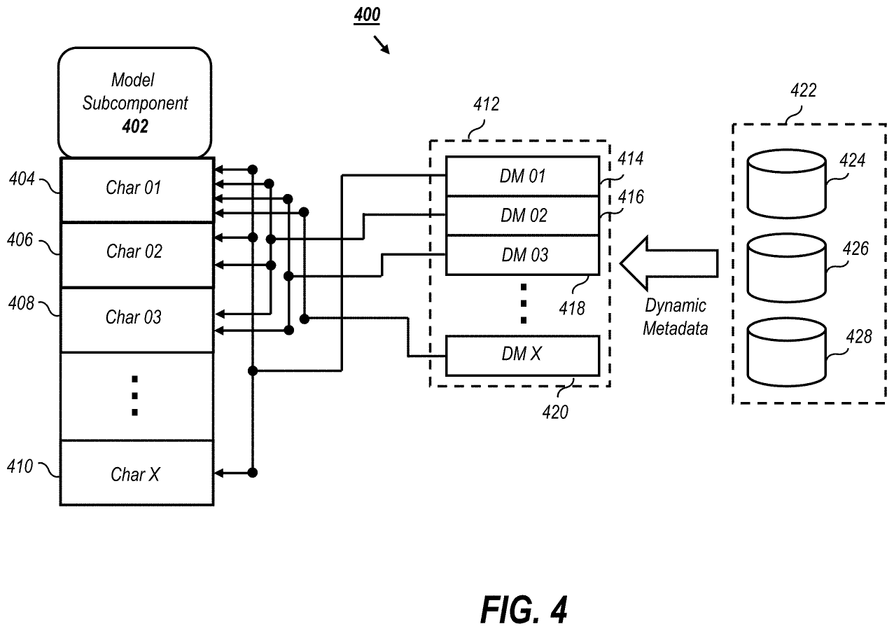

FIG. 4 shows an operating environment 400 for linking dynamic metadata 422, 412 to characteristics 404-410 of a model subcomponent 402 that is configured to be part of a larger 3D model base according to some aspects of the present disclosure. In this example, dynamic metadata may be stored in a central database 422, which may be configured as one or more databases 424-428. In some examples, the dynamic metadata may be automatically transmitted, and/or transmitted upon request from a processing device (e.g., 102), wherein the central database 422 transmits the dynamic metadata to the computer network, indicated by the large arrow in the figure. In some examples, the dynamic metadata may be configured as a single dynamic metadata stream (412) that includes a plurality of metadata DM 01-DM X (414-420). In other examples, the dynamic metadata may be configured as a batch of metadata streams (412), where each metadata stream DM 01-DM X (414-420) includes a plurality of dependent or independent dynamic metadata sets (not expressly shown for the sake of brevity). In some examples, each of the dynamic metadata 414-420 may be configured to be transmitted collectively. In other examples, each of the metadata streams 414-420 may be configured to be transmitted at least partially independently of each other. In further examples, the dynamic metadata streams 414-420 may be transmitted to a processing device (e.g., 102) in response to a command from the processing device.

In this example, as can be seen in the figure, a model subcomponent 402 is part of a 3D model base and may be configured to have a plurality of characteristic data char 01-char X (404-410) associated with the model subcomponent 402. While the characteristic data 404-410 is shown as a linear stack of data of data, those skilled in the art will understand that the characteristic data may be further configured to contain dependencies (e.g., char 03 408 characteristic data is dependent on char 01 404 characteristic data). Furthermore, the characteristic data 404-410 may be configured in other data structures such as node and/or tree data structures. The characteristic data 404-410 may be associated or assigned to the model subcomponent 402 using the model metadata circuit 306 and/or model data entry circuit 314, discussed above. Based on the assigned model subcomponent characteristics (404-410), any of dynamic metadata 414-420 may be linked (e.g., via model base processing circuit 328 and/or 3D model base metadata processing circuit 334) to one or more specific characteristics as shown in the figure.

In this example, dynamic metadata 414 may be linked to characteristic data 404, 406 and 410. Similarly, dynamic metadata 416 may be linked to characteristic data 404 and 406. Dynamic metadata 418 may be linked to characteristic data 404 and 408. Dynamic metadata 420 may be linked to characteristic data 404. Of course, these examples are merely illustrative, and those skilled in the art will understand that other manners or structures for linking are contemplated in the present disclosure. Once the dynamic metadata (414-420) is linked, a user may enter a model subcomponent 402 in a 3D model base (e.g., via design tool, see 300), which would result in the model subcomponent being displayed in the rendered 3D model, along with the linked dynamic metadata. This advantageously results in a configuration where a user may design and view a rendered 3D model base and model subcomponents, while at the same time, view the dynamic metadata associated with some or all of the model subcomponents, as the dynamic metadata changes. In some examples, the dynamic metadata may be associated with executable code in the design tool software, allowing a user to select the dynamic metadata of interest, and open a communications application (e.g., via 212) to allow the user to communicate or transact with an entity associated with the selected dynamic metadata of interest.

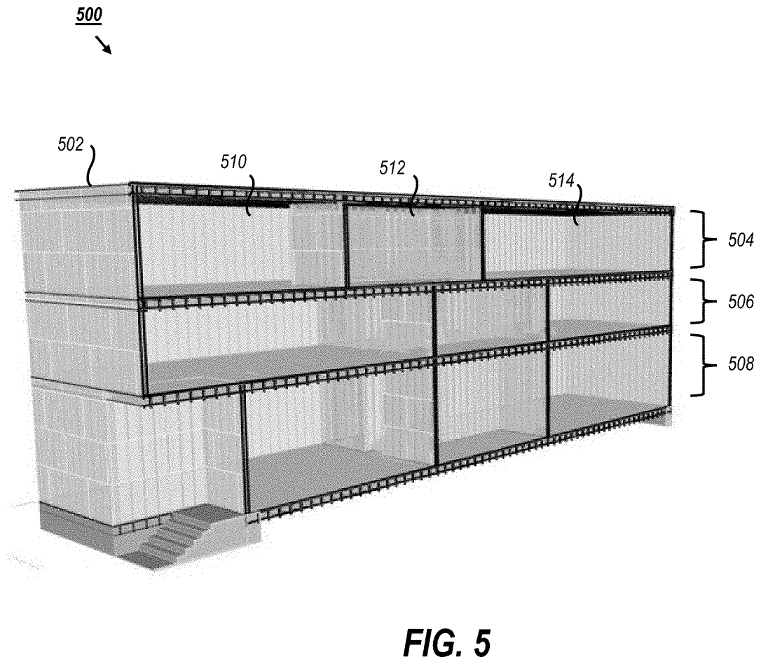

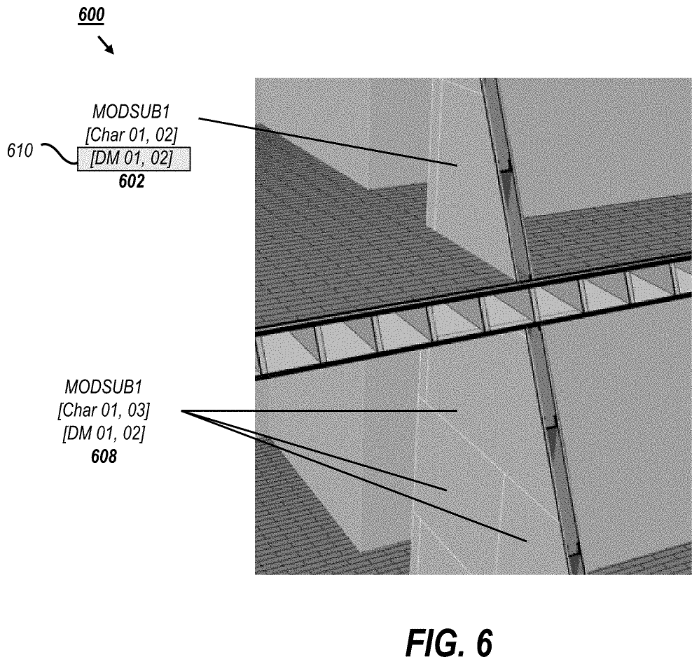

FIG. 5 shows a simulated 3D model base 500 generated on a device (e.g., 202) that includes a plurality of multi-level model subcomponents according to some aspects of the present disclosure. In this example, a rendered 3D model base is shown as structure 502, wherein the overall structure may be characterized in the system as the highest-level (or first-level) model subcomponent. The 3D model base 500 may then be configured where floors or levels of the 3D model base 504, 506, 508 are characterized as second-level model subcomponents. Going further, each second-level model subcomponent, such as floor 504, may be characterized by one or more third-level subcomponents, shown as rooms 510, 512, 514 located on the floor 504. As is discussed in FIG. 6 below, the model subcomponents may be configured to have additional number of still lower levels to reflect subcomponents at a material level. Thus, changes made during the 3D model base design on one level would result the model subcomponent characteristics to change concurrently, and these changes would automatically translate throughout the other levels. Furthermore, as the model subcomponents characteristics change, the dynamic metadata would automatically follow these characteristics. In some, examples, a user may configure the display of dynamic metadata (e.g., via visualization circuit 318) such that dynamic metadata linked to specific characteristics of specific levels, may be displayed or hidden. Such a configuration may be advantageous when a user is working on only a portion (e.g., 504) of a 3D model base, and may not need the dynamic metadata to be displayed on the other portions (e.g., 506, 508).

FIG. 6 shows a simulated portion of a 3D model base 600 generated on a device (e.g., 202) that includes a plurality of lower-level model subcomponents including linked dynamic metadata according to some aspects of the present disclosure. In this example, model subcomponents MODSUB1 602 and MODSUB1 604 are shown as panels in the 3D model base 600, indicating they are a same type, and having at least one same characteristic (char 01). However, as MODSUB1 602 is configured to be on a different level from MODSUB1 604, this characteristic is also reflected in the data, where MODSUB1 602 is assigned char 02, and MODSUB1 604 is assigned char 03. As a higher-level characteristic (char 01) is common between the two model subcomponents, the dynamic metadata may be hierarchically linked to the characteristics such that the dynamic metadata (DM 01, 02) is associated and displayed for both model subcomponents 602, 604. In this example, the 3D design tool may be configured such that the dynamic metadata for MODSUB1 602 is displayed (e.g., via dialog box or other suitable means) and executable (indicated by box 610) to allow a user to select the metadata to allow communication between a first processing device (e.g., 102) and a second processing device (e.g., 104) based on the selected dynamic metadata. Of course, those skilled in the art will understand that the configuration of FIG. 6 is simplifies for the purposes of brevity, and that a multitude of other configurations are contemplated in the present disclosure.

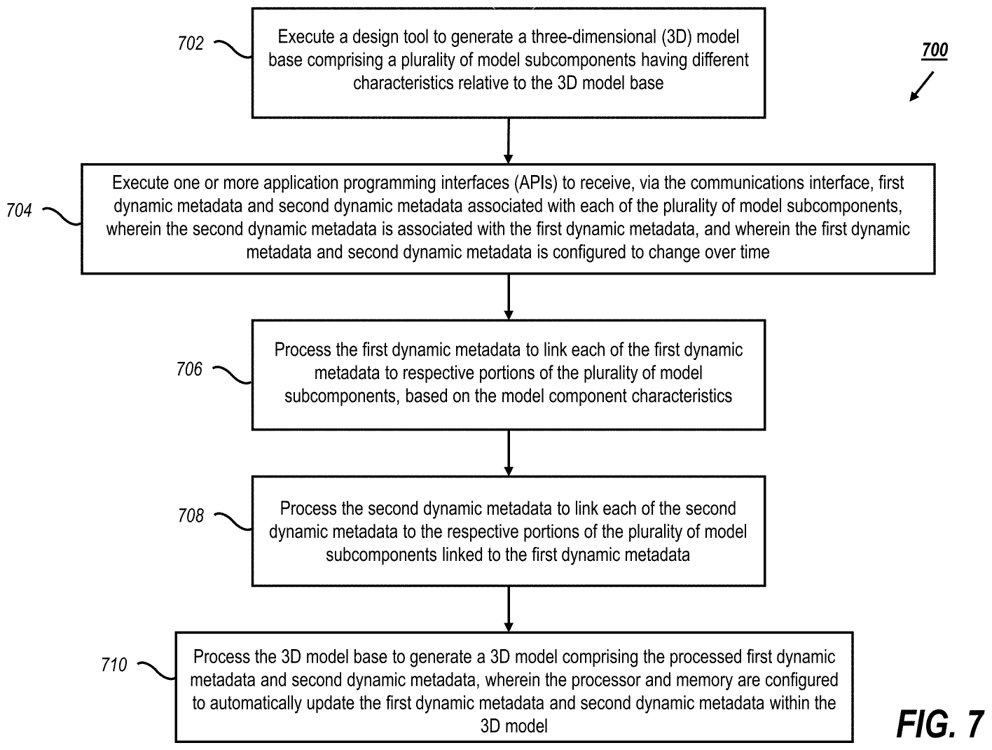

FIG. 7 shows a process for operating a dynamically updatable 3D modelling computer system according to some aspects of the present disclosure. In block 702, a processing device (e.g., 202) may execute a design tool (e.g., 300) to generate a three-dimensional (3D) model base (e.g., 500) comprising a plurality of model subcomponents having different characteristics relative to the 3D model base. In block 704, the processing device may execute one or more application programming interfaces (APIs) (e.g., 310) to receive, via the communications interface (e.g., 212), first dynamic metadata and second dynamic metadata (e.g., 414, 416) associated with each of the plurality of model subcomponents (e.g., 402), wherein the second dynamic metadata is associated with the first dynamic metadata, and wherein the first dynamic metadata and second dynamic metadata is configured to change over time.

In block 706, the processing device may be configured to process the first dynamic metadata to link (e.g., via 306, 314) each of the first dynamic metadata to respective portions of the plurality of model subcomponents, based on the model component characteristics (e.g., 404-410). In block 708, the processing device may process the second dynamic metadata to link each of the second dynamic metadata to the respective portions of the plurality of model subcomponents linked to the first dynamic metadata (see 400), and, in block 710, process the 3D model base to generate a 3D model (500) comprising the processed first dynamic metadata and second dynamic metadata, wherein the processor and memory are configured to automatically update the first dynamic metadata and second dynamic metadata within the 3D model (see 600).

In some examples, the first data may be transmitted to a computer network, wherein the first data is based on the updated first dynamic metadata and second dynamic metadata. Model base metadata may be generated representing a characteristic of the 3D model base, wherein the model base metadata includes at least a portion of the collective first metadata, and the model base metadata may be updated when any of the collective first metadata is updated. In some examples, the design tool may be executed to modify one or more of the plurality of model subcomponents within the 3D model base, and the modification may be communicated to the computer interface, where updated first dynamic metadata is received in response thereto.

In some examples, the design tool may be executed to generate the 3D model base based at least in part on one or more modeling templates, wherein the modeling templates comprise predetermined model subcomponents configured to populate at least a portion of the 3D model base. In some examples, one or more parameter limitations may be received for a model subcomponent having a specified characteristic, where it may be determined if the first dynamic metadata and/or second dynamic metadata are outside the one or more parameter limitations, and the 3D model base may be modified to indicate the model subcomponent having a specified characteristic is outside the one or more parameter limitations.

In some examples, modeling logic 214 (and/or system modeling logic 232) and/or metadata logic 216 (and/or system metadata logic 234) may be configured with learning modules to utilize machine learning processes with respect to the modeling data and associated metadata, such as Analytic Hierarchy Process (AHP) and/or Case-Based Reasoning (CBR). Unlike conventional techniques that produce a single “correct” decision, AHP is configured to be flexible in allowing users to determine a decision that are specific to their goals and understanding of problems. Additionally, AHP provides a comprehensive and rational framework for structuring decision problems, for representing and quantifying its elements, for relating those elements to overall goals, and for evaluating alternative solutions.

When configuring the AHP platform for a system (e.g., 200), decision problems may be decomposed into a hierarchy of more easily comprehended sub-problems, each of which can be analyzed independently. The elements of the hierarchy can relate to any aspect of the decision problem, and may be configured using exact and/or roughly estimated relations applied to specific decisions. Once the hierarchy is built, the system may systematically evaluate its various elements by comparing them to each other using multiples at a time, with respect to their impact on an element above them in the hierarchy. In making the comparisons, the system 200 can use concrete data about the elements, and also provide evaluation data about the elements' relative meaning and importance. The AHP may convert these evaluations to numerical values that can be processed and compared over the entire range of the problem. A numerical weight or priority may be derived for each element of the hierarchy, allowing diverse and often incommensurable elements to be compared to one another in a rational and consistent way. In a final step of the process, numerical priorities may be calculated for each of the decision alternatives. These numbers represent the alternatives' relative ability to achieve a decision goal, so to allow a straightforward consideration of the various courses of action.

When configured for case-based reasoning (CBR), either instead or, or together with AHP, the system 200 may be configured to solve problems by retrieving stored information and metadata of similar problems that have been solved before and adapting their solutions to fit a new situation. Case-based reasoning may be configured as a multi-step process, where a first step may include a retrieve step, where, given a target problem, the system retrieves from memory (e.g., 206, 224) cases relevant to solving it. A case may include a problem, its solution, and, typically, annotations about how the solution was derived. In a reuse step, the system 200 may map the solution from the previous case to the target problem. This may involve adapting the solution as needed to fit the new situation. In a revise step, having mapped the previous solution to the target situation, the system 200 may test the new solution in a simulation and, if necessary, revise. In a retain step, after a solution has been successfully adapted to the target problem, the system 200 may store the resulting experience as a new case in memory (e.g., 206, 224).

In some illustrative embodiments, the system 200 may utilize a multi-instance multi-label (MIML) learning framework where a problem may be described by multiple instances and associated with multiple class labels. The MIML framework may be configured with MIMLBoost and MIMLSvm algorithms based on a simple degeneration strategy, which is advantageous for solving problems involving complicated objects with multiple semantic meanings in the MIML framework. In some illustrative embodiments, a KG-MIML-Net model may be used where, instead of depending on previous given representation of instances or labels, an encoder-decoder framework that can jointly learn and update embedding for instances and labels and build mapping between bag of instances and bag of labels.

A Recurrent Neural Network (RNN) structure may be utilized as the implementation of both encoder and decoder to better capture high-order dependency among instances and labels. Moreover, a residual-supervised attention mechanism may be embedded to assign weights to instances by their level of importance or severity. Additional knowledge may be extracted including contextual knowledge and structural knowledge. In some illustrative embodiments, a contextual layer may be added after decoder to combine the contextual knowledge. Structural knowledge may be utilized such that that the representation of input instances as a leaf node in tree-structure classification scheme is learned depending on its ancestors. The representation of ancestors may be generated by the mean of their direct children, in some illustrative embodiments. A bidirectional long-short term memory (LSTM) may be used to output the tree-embedding given an instance and the tree-structure classification scheme.

It should be understood by those skilled in the art that the terms “problem” and “solution/decision” as used herein should not be interpreted in the abstract. Instead, these terms refer to a baseline dataset having a plurality of data points (problem), entered into the system and subjected to processing (e.g., via processors 210, 228) in order to produce a processed output, based on any of the learning models discussed above.

3D model base data, as well as metadata may be processed in learning modules of the modeling logic and/or metadata logic 216 (and/or 232, 234) which may use any of the techniques described herein to process and calculate/predict appropriate 3D model base configurations and/or subcomponent structures. As discussed above, in one example, a MIML learning framework utilized in learning module may learn one or more functions to predict aspects of metadata for further processing. The learning modules should be configured to learn complex dependencies between bags of instances and labels, as well as among the instances and labels by processing contextual knowledge in the form of a summarization of instances.

To address data skewness in both instance space and label space, a learning module may utilize machine learning techniques to process complicated objects derived from 3D model data and metadata having multiple semantic meanings. In cases where complicated objects derived from the data have multiple semantic meanings, the learning module may be configured model high-order dependency and assume the representation of instances or labels to learn robust representation and build complex dependencies. Here, deep learning models, such as KG-MIML-Net may be utilized, where, instead of depending on previous given representation of instances or labels, an encoder-decoder framework may be used to jointly learn and update embedding for instances and labels and build mapping between bag of instances and bag of labels. An RNN structure may be utilized as an implementation of both encoder and decoder to better capture high-order dependency among instances and labels. Moreover, a residual-supervised attention mechanism may be embedded in a learning module to assign weights to instances by their importance.

In some illustrative embodiments, the weights may be represented as values associated with building efficiency, subcomponent arrangement, or any other suitable weight for predicting 3D modeling data and metadata. Additional knowledge may also by extracted in a learning module to include contextual knowledge data and structural knowledge data, where contextual knowledge data may be derived from the 3D model base/subcomponent data and/or metadata. Structural knowledge data may be configured as an instance and/or label ontology configured as a tree-structure classification scheme. The contextual layer of a learning module may be configured to be after the decoder to combine the personal contextual knowledge data, and structural knowledge data may be utilized such that the representation of input instances as the leaf node the in tree-structure classification scheme is learned depending on its ancestors. The representation of ancestors may be generated by the mean of their direct children. A Bi-LSTM may output the tree-embedding given an instance and the tree-structure classification scheme.

The figures and descriptions provided herein may have been simplified to illustrate aspects that are relevant for a clear understanding of the herein described devices, structures, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

The disclosed embodiments may be implemented, in some cases, in hardware, firmware, software, or any tangibly-embodied combination thereof. The disclosed embodiments may also be implemented as instructions carried by or stored on one or more non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A dynamically updatable computer system, comprising:
a communications interface, configured to communicate over a computer network;
a memory; and
a processor, communicatively coupled to the communications interface and memory, wherein the processor and memory are configured to:
execute a design tool to generate a three-dimensional (3D) model base comprising a plurality of model subcomponents having different characteristics relative to the 3D model base;
execute one or more application programming interfaces (APIs) to receive, via the communications interface, first dynamic metadata and second dynamic metadata associated with each of the plurality of model subcomponents, wherein the second dynamic metadata is associated with the first dynamic, and wherein the first dynamic metadata and second dynamic metadata is configured to change over time;
process the first dynamic metadata to link each of the first dynamic metadata to respective portions of the plurality of model subcomponents, based on the model component characteristics;
process the second dynamic metadata to link each of the second dynamic metadata to the respective portions of the plurality of model subcomponents linked to the first dynamic metadata; and
process the 3D model base to generate a 3D model comprising the processed first dynamic metadata and second dynamic metadata, wherein the processor and memory are configured to automatically update the first dynamic metadata and second dynamic metadata within the 3D model.

2. The dynamically updatable computer system of claim 1, wherein the processor and memory are further configured to transmit first data to the computer network via the communications interface, wherein the first data is based on the updated first dynamic metadata and second dynamic metadata.

3. The dynamically updatable computer system of claim 1, wherein the processor and memory are configured to generate model base metadata representing a characteristic of the 3D model, wherein the model base metadata comprises at least a portion of the collective first metadata.

4. The dynamically updatable computer system of claim 3, wherein the processor and memory are configured to automatically update the model base metadata when any of the collective first metadata is updated.

5. The dynamically updatable computer system of claim 1, wherein the processor and memory are configured to execute the design tool to modify one or more of the plurality of model subcomponents within the 3D model base, communicate the modification to the computer interface, and receive updated first dynamic metadata in response thereto.

6. The dynamically updatable computer system of claim 1, wherein the processor and memory are configured to execute the design tool to generate the 3D model base based at least in part on one or more modeling templates, wherein the modeling templates comprise predetermined model subcomponents configured to populate at least a portion of the 3D model base

7. The dynamically updatable computer system of claim 1, wherein the processor and memory are configured to
receive one or more parameter limitations for a model subcomponent having a specified characteristic,
determine if the first dynamic metadata and/or second dynamic metadata are outside the one or more parameter limitations, and
modify the 3D model base to indicate the model subcomponent having a specified characteristic is outside the one or more parameter limitations.

8. A method for operating a dynamically updatable computer system, comprising:
executing a design tool via a processing apparatus to generate a three-dimensional (3D) model base comprising a plurality of model subcomponents having different characteristics relative to the 3D model base;
executing one or more application programming interfaces (APIs) via a processing apparatus to receive, via a communications interface, first dynamic metadata and second dynamic metadata associated with each of the plurality of model subcomponents, wherein the second dynamic metadata is associated with the first dynamic metadata, and wherein the first dynamic metadata and second dynamic metadata is configured to change over time;
processing, via a processing apparatus, the first dynamic metadata to link each of the first dynamic metadata to respective portions of the plurality of model subcomponents, based on the model component characteristics;
processing, via a processing apparatus, the second dynamic metadata to link each of the second dynamic metadata to the respective portions of the plurality of model subcomponents linked to the first dynamic metadata; and
processing, via a processing apparatus, the 3D model base to generate a 3D model comprising the processed first dynamic metadata and second dynamic metadata, wherein the processor and memory are configured to automatically update the first dynamic metadata and second dynamic metadata within the 3D model.

9. The method of claim 8, further comprising transmitting first data to a computer network via the communications interface, wherein the first data is based on the updated first dynamic metadata and second dynamic metadata.

10. The method of claim 8, further comprising generating model base metadata representing a characteristic of the 3D model base, wherein the model base metadata comprises at least a portion of the collective first metadata.

11. The method of claim 10, further comprising automatically updating the model base metadata when any of the collective first metadata is updated.

12. The method of claim 8, further comprising executing the design tool to modify one or more of the plurality of model subcomponents within the 3D model base, and communicating the modification to the computer interface, and receiving updated first dynamic metadata in response thereto.

13. The method of claim 8, further comprising executing the design tool to generate the 3D model base based at least in part on one or more modeling templates, wherein the modeling templates comprise predetermined model subcomponents configured to populate at least a portion of the 3D model base.

14. The method of claim 8, further comprising:
receiving one or more parameter limitations for a model subcomponent having a specified characteristic,
determining if the first dynamic metadata and/or second dynamic metadata are outside the one or more parameter limitations, and
modifying the 3D model base to indicate the model subcomponent having a specified characteristic is outside the one or more parameter limitations.

15. A computer-readable medium having stored therein instructions executable by one or more processors for operating a dynamically updatable computer system, to:
execute a design tool via a processing apparatus to generate a three-dimensional (3D) model base comprising a plurality of model subcomponents having different characteristics relative to the 3D model base;
execute one or more application programming interfaces (APIs) via a processing apparatus to receive, via a communications interface, first dynamic metadata and second dynamic metadata associated with each of the plurality of model subcomponents, wherein the second dynamic metadata is associated with the first dynamic metadata, and wherein the first dynamic metadata and second dynamic metadata is configured to change over time;
process the first dynamic metadata to link each of the first dynamic metadata to respective portions of the plurality of model subcomponents, based on the model component characteristics;
process the second dynamic metadata to link each of the second dynamic metadata to the respective portions of the plurality of model subcomponents linked to the first dynamic metadata; and
process the 3D model base to generate a 3D model comprising the processed first dynamic metadata and second dynamic metadata, wherein the processor and memory are configured to automatically update the first dynamic metadata and second dynamic metadata within the 3D model.

16. The computer-readable medium of claim 15, further comprising transmit first data to a computer network, wherein the first data is based on the updated first dynamic metadata and second dynamic metadata.

17. The computer-readable medium of claim 15, further comprising:
generate model base metadata representing a characteristic of the 3D model base, wherein the model base metadata comprises at least a portion of the collective first metadata; and
automatically update the model base metadata when any of the collective first metadata is updated.

18. The computer-readable medium of claim 15, further comprising execute the design tool to modify one or more of the plurality of model subcomponents within the 3D model base, and communicate the modification to the computer interface, and receiving updated first dynamic metadata in response thereto.

19. The computer-readable medium of claim 15, further comprising execute the design tool to generate the 3D model base based at least in part on one or more modeling templates, wherein the modeling templates comprise predetermined model subcomponents configured to populate at least a portion of the 3D model base.

20. The computer-readable medium of claim 8, further comprising:
receive one or more parameter limitations for a model subcomponent having a specified characteristic,
determine if the first dynamic metadata and/or second dynamic metadata are outside the one or more parameter limitations, and
modify the 3D model base to indicate the model subcomponent having a specified characteristic is outside the one or more parameter limitations.
